(19) United States
(12) Patent Application Publication
(10) Pub. No.: US 2007/0088548 A1
(43) Pub. Date: Apr. 19, 2007

(54) Device, method, and computer program product for determining speech/non-speech

(75) Inventors: Koichi Yamamoto, Kanagawa (JP); Akinori Kawamura, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/582,547

(22) Filed: Oct. 18, 2006

(30) Foreign Application Priority Data
Oct. 19, 2005 (JP) 2005-304770

(51) Int. Cl. G10L 15/00

(52) U.S. Cl. 704/239

(57) ABSTRACT

A first storage unit stores a transformation matrix, and a second storage unit stores a first parameter of a speech model and a second parameter of a non-speech model. A dividing unit divides an acoustic signal into a plurality of frames. An extracting unit extracts a feature vector from acoustic signals of the frames, a transforming unit linearly transforms the feature vector, and a determining unit determines whether a specific frame among the frames is a speech frame or a non-speech frame.

### CROSS-REFERENCE TO RELATED APPLICATIONS

This application is based upon and claims the benefit of priority from the prior Japanese Patent Application No. 2005-304770, filed on Oct. 19, 2005; the entire contents of which are incorporated herein by reference.

### BACKGROUND OF THE INVENTION

1. Field of the Invention

The present invention relates to a device, a method, and a computer program product for determining whether an acoustic signal is a speech signal or a non-speech signal.

2. Description of the Related Art

In a conventional method for determining whether an acoustic signal is a speech signal or a non-speech signal, a feature value is extracted from an acoustic signal of each frame, and by comparing the feature value with a threshold it is determined whether the acoustic signal of that frame is a speech signal or a non-speech signal. The feature value can be a short-term power or a cepstrum. Because the feature value is calculated from data of only a single frame, naturally it does not contain any time-varying information, so that it is not the best for the speech/non-speech single determination.

In the method disclosed in N. Binder, K. Markov, R. Gruhn, and S. Nakamura, “SPEECH-NON-SPEECH SEPARATION WITH GMMS” Acoustical Society of Japan 2001 fall season symposium, Vol. 1, pp. 141-142, 2001, the Mel Frequency Cepstrum Coefficient (MFCC) extracted from each of a plurality of frames are combined to form a vector, and the vector is used as the feature value.

When a feature vector is calculated from data of plural frames in this manner, the feature vector contains time-varying information, and it becomes possible to extract the time-varying information. Therefore, it becomes possible to provide a robust system that can determine, even if an acoustic signal contains noise, whether the acoustic signal is a speech signal or a non-speech signal.

On the other hand, when a feature vector is extracted from data of plural frames, a high-dimensional feature vector is generated, and the amount of calculation disadvantageously increases. One known method for taking care of this issue is to transform the high-dimensional feature vector into a low-dimensional feature vector. Such a transformation can be performed by way of linear transformation using a transformation matrix.

The Principal Component Analysis (PCA) and Karhunen-Loeve Expansion (KL Expansion) are examples of the transformation matrix. A conventional technique has been disclosed in, for example, Ken-ichiro Ishii, Naonori Ueda, Eisaku Maeda, and Hiroshi Murase, “Wakari-yasui (comprehensible) Pattern Recognition”, Ohm-sya, Aug. 20, 1998, ISBN: 4274131491.

The transformation matrix is, however, acquired through learning to provide the best approximation based on samples acquired through learning before the transformation. Therefore, in this technique an optimal transformation cannot be selected.

Thus, to perform accurate speech/non-speech signal determination, there is a need for a technology that makes it possible to perform optimal transformation, irrespective of whether a high-dimensional feature vector is to be transformed into a low-dimensional feature vector or a feature vector of a specific dimension is to be transformed to another feature vector of the same dimension.

### SUMMARY OF THE INVENTION

According to an aspect of the present invention, a speech/non-speech determining device includes a first storage unit that stores therein a transformation matrix, wherein the transformation matrix is calculated based on an actual speech/non-speech likelihood calculated from a known sample acquired through learning; a second storage unit that stores therein a first parameter of a speech model and a second parameter of a non-speech model, wherein the first parameter and the second parameter are calculated based on the speech/non-speech likelihood; an acquiring unit that acquires an acoustic signal; a dividing unit that divides the acoustic signal into a plurality of frames; an extracting unit that extracts a feature vector from acoustic signals of the frames; a transforming unit that linearly transforms the feature vector using the transformation matrix stored in the first storage unit thereby obtaining a linearly-transformed feature vector; and a determining unit that determines whether each frame among the frames is a speech frame or a non-speech frame based on a result of comparison between the linearly-transformed feature vector and the first parameter, between the linearly-transformed feature vector and the second parameter stored in the second storage unit.

According to another aspect of the present invention, a method of determining speech/non-speech includes acquiring an acoustic signal; dividing the acoustic signal into a plurality of frames; extracting a feature vector from acoustic signals of the frames; linearly transforming the feature vector using a transformation matrix, the transformation matrix being stored in a first storage unit and is calculated based on actual speech/non-speech likelihood calculated for a predetermined sample acquired through learning; and determining whether a frame among the frames is a speech frame or a non-speech frame based on result of comparison between linearly-transformed feature vector and a first parameter of a speech model, between linearly-transformed feature vector and a second parameter of a non-speech model, the first parameter and the second parameter being stored in a second storage unit and calculated based on the speech/non-speech likelihood stored in the first storage unit.

According to still another aspect of the present invention, a computer program product that includes a computer-readable recording medium that stores therein a computer program containing a plurality of commands that cause a computer to perform speech/non-speed determination including acquiring an acoustic signal; dividing the acoustic signal into a plurality of frames; extracting a feature vector from acoustic signals of the frames; linearly transforming the feature vector using a transformation matrix, the transformation matrix being stored in a first storage unit and is calculated based on actual speech/non-speech likelihood calculated for a predetermined sample acquired through learning; and determining whether a frame among the frames is a speech frame or a non-speech frame based on result of comparison between linearly-transformed feature vector and a first parameter of a speech model, between linearly-transformed feature vector and a second parameter of a non-speech model, the first parameter and the second parameter being stored in a second storage unit and calculated based on the speech/non-speech likelihood stored in the first storage unit.

### BRIEF DESCRIPTION OF THE DRAWINGS

FIG. 1 is a block diagram of a speech-section detecting device according to a first embodiment of the present invention;

FIG. 2 is a flowchart of a speech section detecting process performed by the speech-section detecting device shown in FIG. 1;

FIG. 3 is a schematic for explaining the process for detecting beginning and end of speech;

FIG. 4 depicts a hardware configuration of the speech-section detecting device shown in FIG. 1;

FIG. 5 is a block diagram of a speech-section detecting device according to a second embodiment of the present invention; and

FIG. 6 is a flowchart of a parameter updating process performed in a learning mode by the speech-section detecting device shown in FIG. 5.

### DETAILED DESCRIPTION OF THE INVENTION

Exemplary embodiments of a device, a method, and a computer program product according to the present invention are described in detail below with reference to the accompanying drawings. The present invention is not limited to the embodiments explained below.

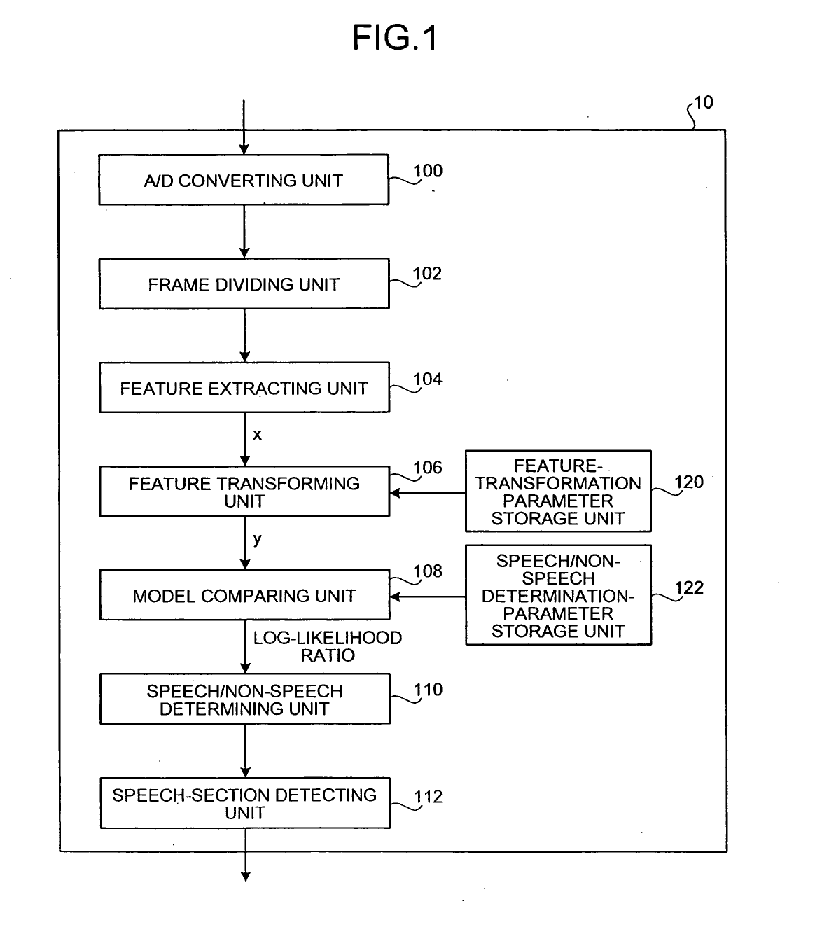

FIG. 1 is a block diagram of a speech-section detecting device 10 according to a first embodiment of the present invention. The speech-section detecting device 10 includes an A/D converting unit 100, a frame dividing unit 102, a feature extracting unit 104, a feature transforming unit 106, a model comparing unit 108, a speech/non-speech determining unit 110, a speech-section detecting unit 112, a feature-transformation parameter storage unit 120, and a speech/non-speech determination-parameter storage unit 122.

The A/D converting unit 100 converts an analog input signal into a digital signal by sampling the analog input signal at a certain sampling frequency. The frame dividing unit 102 divides the digital signal into a specific number of frames. The feature extracting unit 104 extracts an n-dimensional feature vector from the signal of the frames.

The feature-transformation parameter storage unit 120 stores therein the parameters to be used in a transformation matrix.

The feature transforming unit 106 linearly transforms the n-dimensional feature vector into an m-dimensional feature vector (m<n) by using the transformation matrix. It should be noted that n can be equal to m. In other words, the feature vector can be transformed into a different but same-dimensional feature vector.

The speech/non-speech determination-parameter storage unit 122 stores therein parameters of a speech model and parameters of a non-speech model. The parameters of the speech and the parameters of the non-speech are to be compared with the feature vector.

The model comparing unit 108 calculates an evaluation value based on comparison of the m-dimensional feature vector with the speech model and the non-speech model, which are acquired through learning in advance. The speech model and the non-speech model are determined from the parameters of the speech model and the parameters of the non-speech model present in the speech/non-speech determination-parameter storage unit 122.

The speech/non-speech determining unit 110 determines whether each frame among the frames is a speech frame or a non-speech frame by comparing the evaluation value with a threshold. The speech-section detecting unit 112 detects, based on the result of determination obtained by the speech/non-speech determining unit 110, a speech section in the acoustic signal.

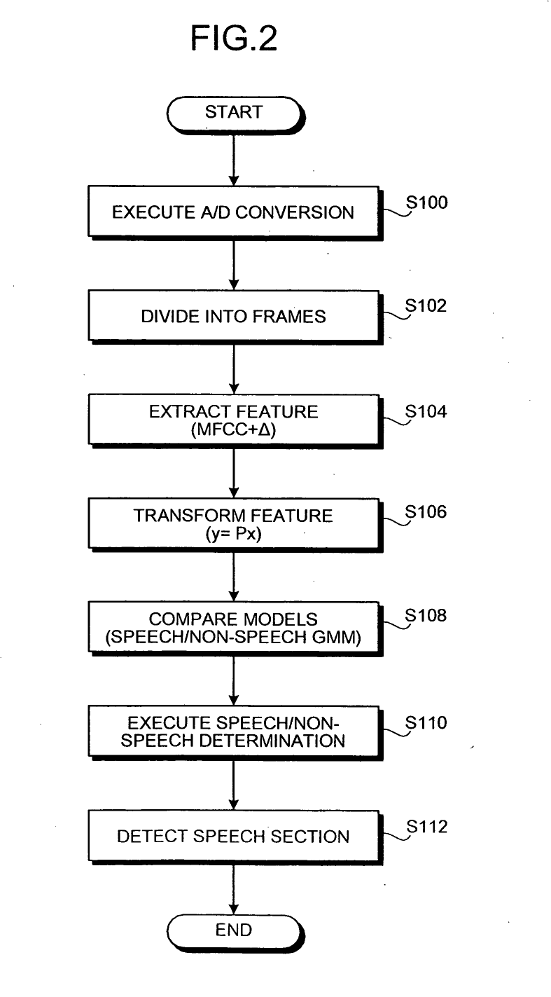

FIG. 2 is a flowchart of a speech section detecting process performed by the speech-section detecting device 10. First, the A/D converting unit 100 acquires an acoustic signal from which a speech section is to be detected and converts the analog acoustic signal to a digital acoustic signal (step S100). Next, the frame dividing unit 102 divides the digital acoustic signal into a specific number of frames (step S102). The length of each frame is preferably from 20 milliseconds to 30 milliseconds, and the interval between two adjacent frames is preferably from 10 milliseconds to 20 milliseconds. A Hamming window can be used to divide the digital acoustic signal into frames.

Next, the feature extracting unit 104 extracts an n-dimensional feature vector from acoustic signal of the frames (step S104). In particular, first, MFCC is extracted from the acoustic signal of each frame. MFCC represents a spectrum feature of the frame. MFCC is widely used as a feature value in the field of speech recognition.

Next, a function delta at a specific time t is calculated using Equation 1. The function delta is a dynamic feature value of the spectrum acquired from a specific number, e.g., three to six, of frames both before and after a frame corresponding to the time t.

$${Δ}_{i} ( t ) = \frac{{\sum }_{k = - K}^{K} {kx}_{i} ( t + k )}{{\sum }_{k = - K}^{K} {k}^{2}} \qquad ( 1 )$$

Subsequently, an n-dimensional feature vector x(t) is calculated from the delta by using Equation 2.
x(t)=[xᵢ(t), . . . , x_{N}(t), Δᵢ(t) . . . , Δ_{N}(t)]^{T} (2)
In Equations 1 and 2, xᵢ(t) represents i-dimensional MFCC; Δᵢ(t) is an i-dimensional delta feature value; K is the number of frames used to calculate the delta; and N is the number of dimensions.

As expressed in Equation 2, the feature vector x is produced by combining MFCC, which is a static feature value, and the function delta, which is a dynamic feature value. Moreover, the feature vector x represents a feature value reflected by the spectrum information of the frames.

As explained above, when plural frames are used, it becomes possible to extract time-varying information of the spectrum. Namely, information that is more effective for performing the speech/non-speech determination is included in the time-varying information as compared to information included in the feature value (such as MFCC) extracted from a single frame.

It is also possible to use a vector obtained by combining a plurality of a single-frame feature values. In this case, the feature vector x(t) at time t is expressed by:
z(t)=[xᵢ(t), . . . , x_{N}(t)]^{T} (3)
x(t)=[z(t−Z)^{T}, . . . , z(t−1)^{T}, z(t)^{T}, z(t+1)^{T}, . . . , z(t+Z)^{T}]^{T} (4)
where z(t) is the MFCC at time t; and Z is the number of frames that are used in combining both before and after the frame corresponding to time t.

The feature vector x expressed by Equation 4 also combines the feature values of plural frames. In addition, the feature vector x expressed by Equation 4 combines the feature values including the time-varying information of the spectrum.

Although MFCC is used as a single-frame feature value, it is possible to use FFT power spectrum, feature values of the Mel Filter Bank analysis and LPC cepstrum etc. instead of MFCC.

Next, the feature transforming unit 106 transforms the n-dimensional feature vector into an m-dimensional feature vector (m<n) using the transformation matrix present in the feature-transformation parameter storage unit 120 (step S106).

The feature vector includes a feature value produced based on the information of a plurality of frames and is generally higher-dimensional feature vector than a feature vector based on a single frame. Therefore, to reduce the amount of calculations, the feature transforming unit 106 transforms the n-dimensional feature vector x into the m-dimensional feature vector y (m<n) using the following linear transformation:
y=Px (5)
where P is an mxn transformation matrix. The transformation matrix P is acquired through learning using a method such as the PCA or the KL expansion to provide the best approximation of the distribution. The transformation matrix P is described later.

Next, the model comparing unit 108 calculates an evaluation value LR indicative of the likelihood of speech (log-likelihood ratio) using the m-dimensional feature vector and speech/non-speech Gaussian Mixture Model (GMM) acquired through learning in advance (step S108) as follows:
LR=g(y|speech)−g(y|nonspeech) (6)
where g(|speech) is the log-likelihood of the speech GMM, and g(|nonspeech) is the log-likelihood of the non-speech GMM.

Each GMM is acquired through learning based on the maximum likelihood criteria using the Expectation-Maximization algorithm (EM algorithm). The value of each GMM is described later.

Although the GMM is used as the speech model and the non-speech model, any other model can be used. For example, it is possible to use the Hidden Markov Model (HMM) or the VQ codebook instead of the GMM.

Next, the speech/non-speech determining unit 110 determines whether each frame among the frames is a speech frame, which contains speech signal, or a non-speech frame, which does not contain speech frame, based on comparison of an evaluation value LR of the frame, which indicates the likelihood of a speech and obtained at step S108, with a threshold θ as expressed by Equation 7 (step S110):
if (LR>θ) speech
if (LR≦θ) nonspeech (7)

The threshold θ can be set as desired. For example, threshold θ can be set to zero.

Next, the speech-section detecting unit 112 detects a rising edge and a falling edge of a speech section of an input signal based on a result of determination of each frame (step S112). The speech section detecting process ends here.

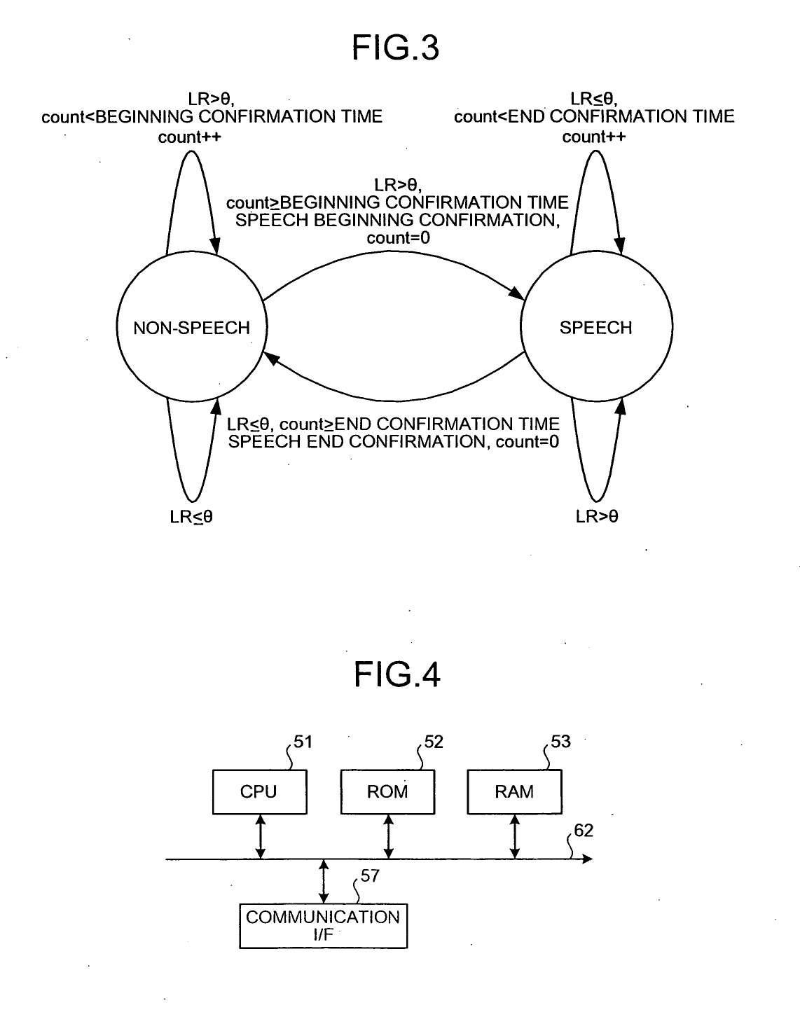

FIG. 3 is a schematic for explaining detection of a rising edge and a falling edge of a speech section. The speech-section detecting unit 112 detects the rising edge or a falling edge of a speech section using the Finite-state Automaton method. The Automaton operates based on a result of determination of each frame.

The default state is set to non-speech, and a timer counter is set to zero in the default state. When a result of determination for a frame indicates that the frame is a speech frame, the timer counter starts counting time. When a result of determination indicates that speech frames continue for a prespecified time, it is determined that the speed section has begun. Namely, that particular time is determined to be the rising edge of the speech. When the rising edge is confirmed, the timer counter is reset to zero, and an operation for a speech processing is started. On the other hand, when a result of determination indicates that the frame is a non-speech frame, counting of time is continued.

After the operation mode is switched to the speech state, when a result of determination becomes non-speech, the time counter starts counting time. When a result of determination indicates a non-speech state for the prespecified period for confirmation of a falling edge of a speed, a falling edge of the speech is confirmed. Namely, the end of the speech is confirmed.

The time for confirming a rising edge and that for confirming a falling edge of a speed can be set as desired. For example, the time for confirming the rising edge is preset to 60 milliseconds, and the time for confirming the falling edge is preset to 80 milliseconds.

As described above, it is possible to use the time-varying information for a feature value by extracting an n-dimensional feature vector from an acoustic input signal of each frame. Namely, it is possible to extract a feature value more effective for speech/non-speech determining process as compared to a feature value of a single frame. In this case, more accurate speech/non-speech determination can be performed. In addition, a speech section can be detected more accurately.

In the process described above, a transformation matrix used in the feature transforming unit 106, in other words, the parameters of the transformation matrix stored in the feature-transformation parameter storage unit 120 (elements of the transformation matrix P), are acquired through learning using a sample acquired through learning. The sample acquired through learning is an acoustic signal, and the evaluation value is known by comparison to the speech/non-speech models.

The parameters of the transformation matrix acquired through learning are registered in the feature-transformation parameter storage unit 120. The parameters of the transformation matrix P are elements of the transformation matrix; and the parameters of the GMM include mean vectors, variances, and mixture weights.

Likewise, the speech/non-speech determining parameters used by the model comparing unit 108, or namely, the speech/non-speech determining parameters stored in the speech/non-speech determination-parameter storage unit 122, are acquired through learning in advance using a sample acquired through learning. The speech/non-speech determining parameters (speech/non-speech GMM) acquired through learning are registered in the speech/non-speech determination-parameter storage unit 122.

The speech-section detecting device 10 makes optimal parameters of the transformation matrix P and the speech/non-speech GMM by using the Discriminative Feature Extraction (DFE) as a discriminative learning method.

The DFE simultaneously optimizes a feature extracting unit (i.e., the transformation matrix P) and a discriminating unit (i.e., the speech/non-speech GMM) by way of the Generalized Probabilistic Descent (GPD) based on the Minimum Classification Error (MCE). The DFE is applied mainly to speech recognition and character recognition, and the effectiveness of the DFE has been reported. The character recognition technique using the DFE is described in detail in, for example, Japanese Patent 3537949. Described below is a process for determining the transformation matrix P and the speech/non-speech GMM registered in the speech-section detecting device 10. Data is classified into either one of the two classes: speech (C₁) and non-speech (C₂). All of the parameter sets of the transformation matrix P and the speech/non-speech GMM (the elements of the transformation matrix including mean vectors, variances, and mixture weights) are expressed as Λ. g1 is the speech GMM; and g2 is the non-speech GMM.

An m-dimensional feature vector extracted from a sample acquired through learning is given by Equation 8 as follows:
yεCₖ(k=1,2), (8)
and, the following equation is defined for Equation 9:
dₖ(y;Λ)=−gₖ(y;Λ)+gᵢ(y;Λ), where (i≠k). (9)

Dₖ(y:Λ) in Equation 9 is a log-likelihood between gₖ and gᵢ. Dₖ(y:Λ) becomes negative when an acoustic signal, which is a sample acquired through learning, is classified as belonging to the right-answer category. On the other hand, Dₖ(y:Λ) becomes positive when an acoustic signal, which is a sample acquired through learning, is classified as belonging to the wrong-answer category. A loss lₖ due to a classification error (y;Λ) is defined by Equation 10:

$$\begin{matrix}{1}_{k} ( y ; Λ ) = \frac{1}{1 + exp ( - {ad}_{k} )} , & where α > 0.\end{matrix} \qquad ( 10 )$$

The loss lₖ provided by the loss function is closer to 1 (one) when the rate of wrong recognition is larger, and to 0 (zero) when the error rate is smaller. Learning of the parameter set Λ is performed so as to lower the value provided by the loss function. Moreover, Λ is updated as shown in Equation 11:

$$Λ ← Λ - ɛ \frac{\partial {1}_{k}}{\partial Λ} , \qquad ( 11 )$$

where e is a small positive number called a step size parameter. It is possible to optimize Λ, namely, a sample acquired through learning in advance so that the rate of wrong recognition for parameters of both the transformation matrix and the speech/non-speech GMM is minimized, by updating Λ using Equation 11 for a sample acquired through learning in advance.

When parameters of the DFE are adjusted, it is necessary to set default values for the transformation matrix and the speech/non-speech GMM. A value of the mxn transformation matrix calculated by the PCA is used as a default value for P. As a default value for the GMM, a parameter value calculated by the EM algorithm is used.

As explained above, parameters of the transformation matrix P and the speech/non-speech GMM used when an n-dimensional feature vector extracted from the frames is transformed into an m-dimensional vector (m<n) can be adjusted so as to minimize a rate of wrong recognition using the discriminative learning method. Therefore, performance of the speech/non-speech determination can be improved. Furthermore, a speech section can be detected more accurately.

As described above, it is possible to acquire values for the transformation matrix P through learning by means of the PCA or the KL expansion. It is also possible to acquire parameters for the speech/non-speech determination through learning with the EM algorithm. The PCA and the KL expansion are based on the optimal approximation of the samples acquired through learning. Moreover, the EM algorithm is based on the maximum likelihood criteria of a sample acquired through learning. These methods are not the best to acquire parameters through learning for the speech/non-speech determination.

In contrast, the transformation matrix P and the speech/non-speech GMM used by the speech-section detecting device 10 are determined by way of the Discriminative Feature Extraction (DFE), which is one of the discriminative learning methods. Therefore, speech/non-speech determination and detection of a speech section can be performed more accurately.

FIG. 4 depicts a hardware configuration of the speech-section detecting device 10. The speech-section detecting device 10 includes a read only memory (ROM) 52 that stores therein a computer program (hereinafter, “speech-section detecting program”) for detecting the speech section; a central processing unit (CPU) 52 that controls each section of the speech-section detecting device 10 according to a program stored in ROM 52; a random access memory (RAM) 53 that stores therein various data necessary for a control of the speech-section detecting device 10; a communication interface (I/F) 57 that connects the speech-section detecting device 10 to a network (not shown); and a bus 62 that connects the various sections of the speech-section detecting device 10 to each other.

The speech-section detecting program is stored in an installable or executable manner in a computer-readable recording media such as a CD-ROM, a floppy (R) disk (FD), and a digital versatile disc (DVD).

The speech-section detecting device 10 reads out the speech-section detecting program from the recording media. Then, the program is uploaded onto a main memory (not shown), and each of the functional structures explained above is realized on the main memory.

It is also possible to store the speech-section detecting program in a computer attached to the network, which can be the Internet, and to download it via the network.

The present invention is explained above with reference to the exemplary embodiments, but various modifications or alternations are possible within the scope of the present invention.

A speech-section detecting has been described above. However, it is possible to provide a speech/non-speech determining device that determination only whether an acoustic signal is a speech or a non-speech, i.e., does not detect a speech section. The speech/non-speech determining device does not include the functions of the speech-section detecting unit 112 shown in FIG. 1. In other words, the speech/non-speech determining device outputs a result of determination as to whether an acoustic signal is a speech or a non-speech.

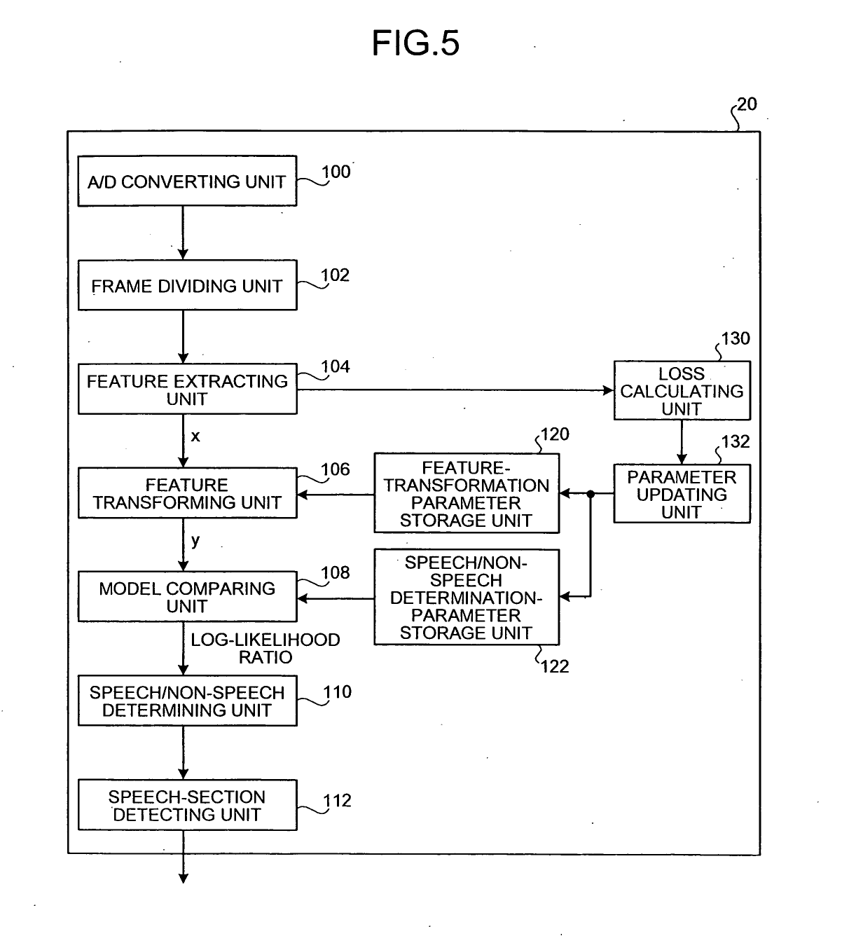

FIG. 5 is a functional block diagram of a speech-section detecting device 20 according to a second embodiment of the present invention. The speech-section detecting device 20 includes a loss calculating unit 130 and a parameter updating unit 132 in addition to the configuration of the speech-section detecting device 10 of the first embodiment.

The loss calculating unit 130 compares the m-dimensional feature vector acquired in the feature extracting unit 104 to the speech and non-speech models respectively, and then calculates the loss expressed by Equation 10.

The parameter updating unit 132 updates both parameters of a transformation matrix stored in the feature-transformation parameter storage unit 120 and the speech/non-speech determining parameters stored in the speech/non-speech determination-parameter storage unit 122 so as to minimize the value of the loss function expressed by Equation 10. In other words, the parameter updating unit 132 calculates (updates) Λ expressed in Equation 11.

The speech-section detecting device 20 has a learning mode and a speech/non-speech determining mode. In the learning mode, the speech-section detecting device 20 processes an acoustic signal as a sample acquired through learning, and the parameter updating unit 132 updates parameters.

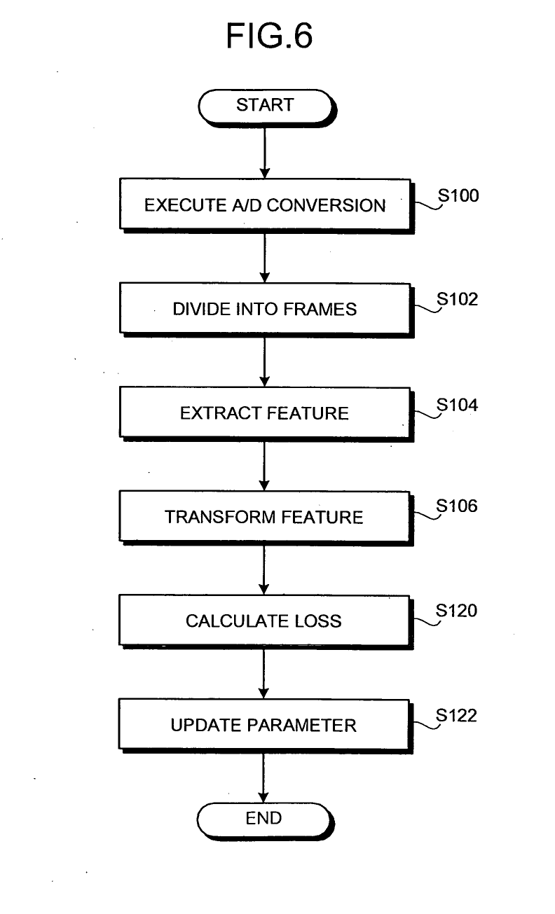

FIG. 6 is a flowchart for explaining the processing for updating parameters in the learning mode. In the learning mode, the A/D converting unit 100 converts a sample acquired through learning from an analog signal into a digital signal (step-S100). Next, the frame dividing unit 102 and the feature extracting unit 104 calculate an n-dimensional feature vector for the sample (steps S102 and S104). Then, the feature transforming unit 106 produces an m-dimensional feature vector (step S106).

Next, the loss calculating unit 130 calculates a loss expressed by Equation 10 using an m-dimensional feature vector acquired at step S106 (step S120). Next, the parameter updating unit 132 updates, based on the loss function, parameters of a transformation matrix (elements of a transformation matrix P) present in the feature-transformation parameter storage unit 120 and the speech/non-speech determining parameters (the speech GMM and the non-speech GMM) present in the speech/non-speech determination-parameter storage unit 122 (step S122). This is the end of the parameter updating process in learning mode.

The procedure described above can be repeated to optimize the parameter set Λ more appropriate, in other words, to reduce a rate of wrong recognition for the transformation matrix P and the speech/non-speech GMM.

In the speech/non-speech determining mode, a speech section can be detected in the same manner as described above with reference to FIG. 2. In this case, whether an acoustic signal is a speech signal or a non-speech signal is checked with the transformation matrix P and the speech/non-speech GMM.

In particular, an n-dimensional feature vector x selected in learning mode is used in step S106. Moreover, the vector x is transformed into an m-dimensional feature vector using the transformation matrix P acquired through learning in the learning mode. Subsequently, in step S108, the log-likelihood ratio is calculated using the speech/non-speech GMM acquired through learning in the learning mode.

In this manner, the parameters of a transformation matrix and the speech/non-speech GMM are acquired through learning in the learning mode. The speech/non-speech determining performance can be improved by adjusting the parameters of the transformation matrix and the speech/non-speech GMM to minimize a rate of wrong recognition by means of the discriminative learning method. The performance of speed section detection can also be improved.

The configuration and processing steps of the speech-section detecting device 20 excluding the points described above are the same as those of the speech-section detecting device 10.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A speech/non-speech determining device comprising:
a first storage unit that stores therein a transformation matrix, wherein the transformation matrix is calculated based on an actual speech/non-speech likelihood calculated from a known sample acquired through learning;
a second storage unit that stores therein a first parameter of a speech model and a second parameter of a non-speech model, wherein the first parameter and the second parameter are calculated based on the speech/non-speech likelihood;
an acquiring unit that acquires an acoustic signal;
a dividing unit that divides the acoustic signal into a plurality of frames;
an extracting unit that extracts a feature vector from acoustic signals of the frames;
a transforming unit that linearly transforms the feature vector using the transformation matrix stored in the first storage unit thereby obtaining a linearly-transformed feature vector; and
a determining unit that determines whether each frame among the frames is a speech frame or a non-speech frame based on a result of comparison between the linearly-transformed feature vector and the first parameter, between the linearly-transformed feature vector and the second parameter stored in the second storage unit.

2. The device according to claim 1, further comprising a comparing unit that compares the linearly-transformed feature vector with the first parameter, compares the linearly-transformed feature vector with the second parameter, wherein
the determining unit determines whether a frame is a speech frame or a non-speech frame by comparing a result of the comparison by the comparing unit with a threshold.

3. The device according to claim 2, further comprising:
a likelihood calculating unit that calculates the speech/non-speech likelihood of the sample; and
a first calculating unit that calculates the transformation matrix based on the speech/non-speech likelihood, wherein
the first storage unit stores therein the transformation matrix calculated by the first calculating unit.

4. The device according to claim 3, wherein the first calculating unit calculates the transformation matrix so as to reduce the difference between the speech/non-speech likelihood calculated for the sample and a speech/non-speech likelihood set for the sample.

5. The device according to claim 3, comprising a learning mode and a speech/non-speech determining mode, wherein
the first calculating unit calculates the transformation matrix when the learning mode is effected.

6. The device according to claim 5, wherein the determining unit determines, when the speech/non-speech determining mode is effected, whether a frame is a speech frame or a non-speech frame.

7. The device according to claim 2, further comprising:
a first calculating unit that calculates the speech/non-speech likelihood of the sample; and
a second calculating unit that calculates the first parameter and the second parameter based on the speech/non-speech likelihood, wherein
the second storage unit stores therein the speech model and the non-speech model calculated by the second calculating unit.

8. The device according to claim 7, wherein the second calculating unit calculates the first parameter and the second parameter to minimize the difference between the speech/non-speech likelihood calculated for the sample and the speech/non-speech likelihood set for the sample.

9. The device according to claim 7, comprising a learning mode and a speech/non-speech determining mode, wherein
the first calculating unit calculates the transformation matrix when the learning mode is effected.

10. The device according to claim 1, wherein the transforming unit linearly transforms the feature vector into a lower-dimensional feature vector.

11. The device according to claim 1, wherein the extracting unit extracts an n-dimensional feature vector that combines static and dynamic spectrums of the acoustic signal.

12. The device according to claim 1, wherein the extracting unit extracts an n-dimensional feature vector that combines spectrum feature values of acoustic signals of the frames.

13. The device according to claim 1, further comprising a detecting unit that detects a speech section based on a result of the determination by the determining unit.

14. A method of determining speech/non-speech, the method comprising:
acquiring an acoustic signal;
dividing the acoustic signal into a plurality of frames;
extracting a feature vector from acoustic signals of the frames;
linearly transforming the feature vector using a transformation matrix, the transformation matrix being stored in a first storage unit and is calculated based on actual speech/non-speech likelihood calculated for a predetermined sample acquired through learning; and
determining whether a frame among the frames is a speech frame or a non-speech frame based on result of comparison between linearly-transformed feature vector and a first parameter of a speech model, between linearly-transformed feature vector and a second parameter of a non-speech model, the first parameter and the second parameter being stored in a second storage unit and calculated based on the speech/non-speech likelihood stored in the first storage unit.

15. The method according to claim 14, wherein the determining includes
comparing the linearly-transformed feature vector with the first parameter, the linearly-transformed feature vector with the second parameter; and
determining whether a frame is a speech frame or a non-speech frame by comparing a result of the comparison obtained at the comparing with a threshold.

16. The method according to claim 15, further comprising:
calculating the speech/non-speech likelihood of the sample;
calculating the transformation matrix based on the speech/non-speech likelihood; and
saving the transformation matrix in the first storage unit.

17. The method according to claim 15, further comprising:
calculating the speech/non-speech likelihood of the sample;
calculating the first parameter and the second parameter based on the speech/non-speech likelihood; and
storing the first parameter and the second parameter in the second storage unit.

18. The method according to claim 14, further comprising linearly transforming the feature vector into a lower-dimensional feature vector.

19. The method according to claim 14, further comprising detecting a speech section based on a result of determination at the determining.

20. A computer program product that includes a computer-readable recording medium that stores therein a computer program containing a plurality of commands that cause a computer to perform speech/non-speed determination including:
acquiring an acoustic signal;
dividing the acoustic signal into a plurality of frames;
extracting a feature vector from acoustic signals of the frames;
linearly transforming the feature vector using a transformation matrix, the transformation matrix being stored in a first storage unit and is calculated based on actual speech/non-speech likelihood calculated for a predetermined sample acquired through learning; and
determining whether a frame among the frames is a speech frame or a non-speech frame based on result of comparison between linearly-transformed feature vector and a first parameter of a speech model, between linearly-transformed feature vector and a second parameter of a non-speech model, the first parameter and the second parameter being stored in a second storage unit and calculated based on the speech/non-speech likelihood stored in the first storage unit.
